(19) United States
(12) Patent Application Publication
(10) Pub. No.: US 2023/0143541 A1
(43) Pub. Date: May 11, 2023

(54) UNDERWATER PROPULSION UNIT

(71) Applicant: Torqeedo GmbH, Wessling (DE)

(72) Inventors: Dominik BUSSE, Wessling (DE); Anton SPENGLER, Wessling (DE); Cedric GOETZE, Wessling (DE)

(21) Appl. No.: 17/984,739

(22) Filed: Nov. 10, 2022

(30) Foreign Application Priority Data
Nov. 11, 2021 (DE) 102021129462.2

(51) Int. Cl. B63H 1/14; B63H 21/17; B63H 21/36; B63H 23/34

(52) U.S. Cl. CPC B63H 1/14; B63H 21/17; B63H 21/36; B63H 23/34

(57) ABSTRACT

An underwater propulsion unit is provided for an outboard motor or a pod drive. The underwater propulsion unit includes a plastic housing designed for water to flow around, and a metal housing in which an electrical drive is received. The electrical drive is received in the metal housing so as to be sealed off from the surroundings in a watertight manner, and the metal housing is arranged inside the plastic housing.

### CROSS-REFERENCE TO RELATED APPLICATION

This application claims priority to German Patent Application No. DE102021129462.2 filed on Nov. 11, 2021, the entire contents of which is hereby incorporated in its entirety by reference.

### FIELD OF THE INVENTION

The present invention relates to an underwater propulsion unit comprising a plastic housing designed for water to flow around, and a metal housing having an electrical drive. The present invention further relates to a system comprising at least two underwater propulsion units of this kind. The present invention further relates to a boat having an underwater propulsion unit of this kind.

### BACKGROUND OF INVENTION

Underwater propulsion units are often equipped with an electrical drive. The development of electrical underwater propulsion units is subject to a plurality of competing demands.

On the one hand, it is necessary to support the propulsion unit in a material having good thermal conductance, in order to prevent the electrical drive or the power components thereof from overheating. For this reason, propulsion units are often mounted in metal housings. On the other hand, the underwater propulsion unit must have optimal flow properties, in order to keep low friction losses when water flows therearound. In this case, special coatings or at least particularly good surface qualities are often used. Furthermore, the metal housing has to be protected against environmental influences, in particular against corrosion associated therewith. However, the combination of a metal housing with low water resistance and a protective coating is associated with significant costs. This contradicts a further important demand, specifically that of saving costs. Thus, in the development of underwater propulsion units, in particular for lower power classes, there are thus conflicting goals of cooling, flow optimization, and cost reduction. Furthermore, the design of the underwater propulsion unit plays a role in the marketability. Individual aspects of these conflicting goals are discussed in the prior art.

EP 2 762 402 A2 discloses a propulsion unit for a ship, in which the cooling of the propulsion unit is achieved in that the motor is cooled both from the inside and from the outside.

A ship drive is known from US 2004014380 A1 which comprises an electric motor in a housing, and furthermore comprises flow openings via which the propulsion unit can be cooled.

US 20070173140 A1 discloses an integrated outboard motor which comprises an electrical drive in a plastic housing.

A disadvantage of the solutions known from the prior art is, however, that none of the known teaching allows a satisfactory solution to the conflicting goals of cooling, flow optimization, and cost saving. Either, according to the prior art, the housing is produced from metal, as a result of which it has to be reworked, for flow optimization, in a laborious and costly manner, or the housing is made of plastic material, as a result of which the cooling of the electrical drive is not optimal.

### SUMMARY OF THE INVENTION

Proceeding from the known prior art, an object of the present invention is that of providing an improved underwater propulsion unit.

The object is achieved by an underwater unit having the features of claim 1. Advantageous developments can be found in the dependent claims, the description and the drawings.

Accordingly, an underwater propulsion unit, preferably for an outboard motor or a pod drive, is proposed, comprising a plastic housing designed for water to flow around, and a metal housing in which an electrical drive is received. According to the invention, the electrical drive is received in the metal housing so as to be sealed off from the surroundings in a watertight manner, and the metal housing is arranged inside the plastic housing.

Since the metal housing is watertight and is arranged inside the plastic housing, a separation of the functions “cooling of the electrical drive” and “flow optimization” is achieved. In other words, a “shell-in-shell” principle is used, specifically a “metal housing-in-plastic housing” principle.

In this case, the function “cooling of the electrical drive” is fulfilled by means of the metal housing, which exhibits good heat-conducting properties and as a result efficiently transports heat from the electrical drive to the medium, water or plastic material surrounding the metal housing.

In this case, the function “flow optimization” is fulfilled by means of the plastic housing, which can be easily and flexibly made into any desired shapes which are optimal for the relevant case of use of the underwater propulsion unit. In particular, the use of a plastic housing makes it possible for costly measures for corrosion protection and for flow-optimizing coating to be avoided, compared with a metal housing, and for the production costs to be reduced.

Therefore, as a result, the metal housing does not have to have any flow-optimized properties or any particular designs, and can be provided with a simple material surface, such that it can thus be constructed in a particularly simple manner. As a result, the metal housing can for example be provided largely having an untreated surface. The metal housing can also be designed having a simple shape, such as a cylindrical shape.

At the same time, the plastic housing does not need to have any sealing properties. The plastic housing can therefore be designed merely with respect to flow requirements.

As a result, the conflict of the goals of cost saving, flow optimization and cooling is overcome in an optimal manner by an underwater propulsion unit comprising a plastic housing designed for water to flow therearound, and a metal housing having an electrical drive, the metal housing being watertight and being arranged inside the plastic housing. Furthermore, on account of the crumple zone, provided by the plastic housing, the metal housing is protected from mechanical energy input, as can occur for example in the case of contact with the ground, and against damage, in particular against water damage, which can lead to total loss of the motor and the electronics. Furthermore, on account of the plastic housing, additional protection of the metal housing from environmental influences can be omitted.

An underwater unit within the meaning of the present disclosure is a pylon of an outboard motor or a pod which, in rated operation of the underwater propulsion unit, is located entirely or in part under the water surface.

Within the meaning of the present disclosure, a plastic housing can be understood to be a housing which comprises a plastic material. In particular, this can be understood to be a housing which is produced exclusively from a plastic material or a plurality of plastic materials or composite materials. The plastic housing can be coated or uncoated. In particular, the plastic housing can be varnished. Alternatively or in addition, the plastic housing can comprise a surface embossing. The surface embossing can preferably be designed such that, when water flows around the plastic housing the friction is reduced.

Within the meaning of the present disclosure, a metal housing can be understood to be a housing which comprises metal. In particular, this can be understood to be a housing which is produced exclusively from metal. For example, the housing can comprise a cast part. The metal housing advantageously comprises an untreated surface. As a result, costs can be saved.

The term “watertight” is to be understood such that, in rated operation of the underwater propulsion unit, no or an only negligible amount of water can penetrate into the metal housing.

Preferably, the electrical drive of the underwater propulsion unit is designed for the lower power classes of underwater propulsion units, in particular as an electrical drive having a power of 0.2 HP to 80 HP, for example between 0.2 to 0.7 HP, 1 to 3 HP, 1.5 to 3 HP, 5 to 20 HP, or 40 to 80 HP (approx. 150 W to 500 W, 730 W to 2.2 kW, 1.1 to 2.2 kW, 3.6 to 14.7 kW or 29.4 to 58 kW). This has the advantage that, in these power classes, particularly high cost savings can be achieved by an underwater propulsion unit as disclosed herein.

The plastic housing advantageously comprises openings which are connected via a flow channel, the plastic housing being designed such that, in the state in which water flows around the plastic housing, it flows at least partially around the metal housing.

Since the plastic housing comprises openings which are connected via a flow channel, and since the plastic housing is designed such that, in the state in which water flows around the plastic housing, it flows at least partially around the metal housing, it is possible to cool the metal housing particularly efficiently. In this case, a coating of the metal housing is not required, since the metal housing is not part of the outer structure, and does not have to fulfill the function of the flow optimization. Therefore, the metal housing does not have to satisfy any particular requirements with respect to flow. At the same time, the metal housing likewise does not have to satisfy any aesthetic requirements, since it is not, or barely, visible from the outside.

Since, in the state in which water flows around the plastic housing, a flow around the metal housing takes place at least in part, cooling of the metal housing, and thus the drive components arranged therein, is possible during operation.

Within the meaning of the present disclosure, a plastic housing designed for water to flow around means a housing which comprises a plastic material and having a finish, in particular outer contour, which is optimized with respect to water flowing therearound.

The plastic housing advantageously comprises at least one inlet opening in the front region, and at least one outlet opening in the rear region, the flow channel extending along the longitudinal axis L of the underwater propulsion unit. In other words, it is thus possible, during operation of the underwater propulsion unit, for water flowing around to enter the plastic housing via the inlet opening, to reach the metal housing via the flow channel, and then to leave the plastic housing via the outlet opening. As a result, a continuous flow around the metal housing can be achieved, which provides optimal cooling of the drive components in operation.

Advantageously, the flow channel is at least partially formed by the metal housing. In other words, the metal housing forms at least one delimitation or wall portion of the flow channel. Since the flow channel is formed by the metal housing, at least in part, in the state in which water flows around the plastic housing, water comes into contact with the metal housing, via the flow channel. The wetting with water optimizes the heat transfer between the metal housing and the water, as a result of which the cooling is further improved.

The plastic housing is advantageously connected to a shaft tube, the connection being achieved via a shaft tube molding. Since the plastic housing is connected to the shaft tube, the metal housing does not have to be welded to or molded onto the shaft tube. Compared with established production methods, such as welding of the shaft tube to the metal housing, or molding of a shaft tube connection onto a metal housing as a cast part, the production costs can thus be significantly reduced, since a number of manufacturing steps, such as turning, drilling, welding or casting, and mechanical reworking, are omitted. Furthermore, the connection of the shaft tube to the plastic housing allows greater design freedom for the configuration of the plastic housing and of the metal housing.

The shaft tube can, however, also be attached directly to the metal housing, for example welded, riveted or screwed thereto, or be formed in one piece therewith. A direct attachment of the shaft tube to the metal housing makes it possible for further improved structural strength to be achieved. In this case, the plastic housing can also be attached to the shaft tube, for example via the molding already mentioned.

The plastic housing can, however, also be merely held on the metal housing, which is in turn attached to the shaft tube. In this embodiment, the plastic housing can comprise a simple opening in the region of the passage of the shaft tube, through which opening the shaft tube is guided, without further fastening of the plastic housing.

The electrical drive advantageously comprises an electric motor, optionally a transmission and/or an electronics component, and drives a propeller via a drive shaft. The mentioned components are then received in the metal housing so as to be sealed off from the surroundings in a watertight manner. A torque for driving the drive shaft can be provided by means of the electric motor. Optionally, the torque can be converted, via a transmission on the drive shaft, into a different torque/speed ratio.

Since the electrical drive comprises an electric motor, a transmission, and/or an electronics component, all the components required for driving the propeller via the drive shaft can be cooled via the metal housing, around which water flows, at least in part, in the state in which water flows around the plastic housing. The entire motor unit is thus accommodated in a metal housing, around which water also flows, at least in part, in the state in which water flows around the plastic housing, and which metal housing is thus cooled.

The metal housing is advantageously designed as a cylindrical metal tube which comprises a front tube seal at the front end thereof, and/or a rear tube seal at the rear end thereof. As a result, the metal housing can be manufactured from a simple tube, which is sealed by covers at both ends thereof. In particular, the tube seal on the rear end can also be part of the metal housing, i.e. formed in one piece with the metal housing.

The metal housing advantageously comprises a cable seal at the front end thereof, for sealing a cable, and/or a shaft seal at the rear end thereof. It is thus possible to ensure that the cable and/or the drive shaft is guided out of the metal housing, without water being able to enter the metal housing via said interfaces. For example, the cables can be guided out of the metal tube by means of a tight screw connection. The use of a cable seal and/or a shaft seal makes it possible to accommodate the entire motor unit in the plastic housing, such that a flow of water around the metal housing, at least in part, is possible without water penetrating into the metal housing.

The plastic housing advantageously comprises a plurality of flow channels. Having a plurality of flow channels on or in the plastic housing has the advantage that water can flow in a more uniform or more targeted manner around the metal housing arranged, and said housing can thus accordingly be cooled better. This furthermore has the advantage that friction losses, which can be caused by the water entering the plastic housing, are uniformly distributed over the plastic housing. As a result, this makes it possible to prevent undesired roll, yawing or pitching moments from being generated on the plastic housing during operation of the underwater propulsion unit.

The flow channels of the plastic housing can preferably comprise protrusions on the plastic housing, as a result of which the effective space between the plastic housing and the metal housing is increased. As a result, the inflow of water at the metal housing can be increased, and the pressure losses resulting in the process can be reduced. Nonetheless, the protrusions can act as longitudinal flow directing elements, as a result of which the stability of the underwater propulsion unit during travel is optimized.

The flow channels are advantageously separated from one another via longitudinal ribs, the longitudinal ribs furthermore fixing the metal housing and the plastic housing to one another. This makes it possible to ensure that the metal housing is arranged easily and securely in the plastic housing. Furthermore, defined flow channels can be formed in this way, via which a previously defined flow around the metal housing can be ensured. As a result, the cooling of the metal housing during operation of the underwater unit can be optimized. In other words, as a result, flow losses induced hydrodynamically during operation can be reduced, as a result of which efficient cooling of the metal housing is made possible.

The flow channels advantageously each open out into separate inlet openings and/or outlet openings in the plastic housing. As a result, the inlet openings and/or the outlet openings can be adjusted in a purposeful manner to the geometry of the corresponding flow channels. The inlet openings can for example have a rectangular cross section having rounded corners. Optionally, the outlet openings can have a substantially oval cross section. In this way, flow losses induced hydrodynamically during operation can be reduced, as a result of which efficient cooling of the metal housing is made possible.

According to an alternative embodiment, the flow channels open out into a common inlet distributor and/or outlet distributor having a common inlet opening or outlet opening, respectively. In this way, hydrodynamically induced flow losses can be further reduced, as a result of which efficient cooling of the metal housing is made possible.

The metal housing is preferably arranged substantially centrally in the plastic housing, the plastic housing preferably comprising a cable guide channel between the metal housing and the plastic housing. The metal housing arranged substantially centrally in the plastic housing makes it possible for the flow channels to be able to be arranged uniformly along the periphery of the plastic housing. Furthermore, it can be ensured thereby that the metal housing is protected on all sides, by the plastic housing, from mechanical energy input, for example in the event of a collision or contact with the ground.

The openings and/or the flow channel preferably comprise fixed or variable flow limitation means, by means of which the flow through the flow channel is adjustable. The use of fixed or variable flow limitation means in the openings and/or the flow channel makes it possible for a targeted supply of the water, flowing around the metal housing, to be set. As a result, the cooling of the metal housing can be varied not only in a speed-dependent manner, but via a further adjustment variable. As a result, the cooling of the metal housing and the drive components arranged therein can be further improved thereby.

The openings and/or the flow channel advantageously comprise turbulators, the turbulators preferably being connected to the metal housing. Since the openings and/or the flow channel comprises turbulators, the heat transfer between the metal housing and the water flowing around the metal housing can be significantly improved. In other words, the turbulators increase turbulent flow portions, as a result of which the heat transport is promoted. This is achieved in particular if the turbulators are connected to the metal housing. In this case, both the turbulent flow portion in the fluid, and the surface of the metal housing available for the heat transport, are increased. Thus, particularly efficient cooling of the metal housing can take place. According to an advantageous development, the turbulators are designed such that the resulting pressure loss is as low as possible, despite turbulence generation. As a result, efficient cooling can be achieved, without this having a noticeable influence on the flow losses.

The underwater propulsion unit can for example be attached to the shaft of an electric outboard motor, it then being possible for inter alia a control unit having an integrated battery pack and pin, or a control unit comprising a pin but without its own battery pack, to be arranged on the top of the shaft. In this case, the shaft of the outboard motor can also be formed by a simply designed metal tube or plastic tube, which is surrounded by a plastic housing.

The underwater propulsion unit can also be arranged in a pod drive arranged exclusively under the water.

In a preferred development, the shaft tube is directly connected to the metal housing, preferably is welded and/or screwed and/or riveted to the metal housing, and/or the shaft tube is formed in one piece with the metal housing.

In terms of the system, the object is furthermore achieved by a system comprising at least two underwater propulsion units according to the present disclosure. In this case, the at least two underwater propulsion units of the system comprise an electrical drive of identical construction and/or a metal housing of identical construction, each electrical drive being pre-set to a specific, different power class, and wherein at least one dimension of the plastic housing is selected depending on the pre-set power class.

In other words, the system is a product range or a product portfolio. The individual, different power classes can be set to their corresponding power class for example by power electronics.

The identically designed electrical drives and/or metal housing makes it possible for identical parts to be installed across products, and thus for costs to be saved. Since the at least one dimension of the plastic housing is selected depending on the pre-set power class, physically necessary or advantageous adjustments to the plastic housing can be performed. In addition, an optical distinguishing feature can also be achieved thereby, which makes it possible to conclude the pre-set power class or allows a visual differentiation of the different pre-set power classes. Improved marketing of the products can be achieved thereby.

Within the meaning of the present disclosure, a pre-set power class means a power upper limit fixed by the manufacturer which the end user cannot amend as wished without carrying out extensive manipulation on the underwater propulsion unit, such as by chip tuning or the like.

For example, at least two of the five power classes mentioned here can be pre-set, for example 0.2 to 0.7 HP, 1 to 3 HP, 1.5 to 3 HP, 5 to 20 HP or 40 to 80 HP. Drives which are suitable for at least two of the mentioned power classes can for example comprise the same power electronics, the same metal housing, and the same electrical drive. In particular, one of the possible power classes can then be set by setting the power electronics, for example by switching a switch or a jumper, or by programming or installing a drive controller.

In other words, drives of different power classes can be provided using identical hardware. For the different power classes, however, a differently designed plastic housing can be selected in each case, such that the size and shape of the housing can be adjusted to the need for protection and the required flow properties, and in particular heat dissipation requirements, of the power class selected in each case.

For example, in an underwater propulsion unit of the 0.2 to 0.7 HP class, a small crumple zone and a low cooling power is sufficient, such that the plastic housing can be designed so as to be small. However, in the case of an underwater propulsion unit of the 40-80 HP class, a large crumple zone and a high cooling power is required, such that the plastic housing can be designed so as to be larger, and in particular can also be designed so as to be more robust. In particular, the wall thickness of the plastic housing can be increased. Furthermore, the flow properties of the plastic housing of the 40-80 HP class can be adjusted to the greatest achievable speed and the greatest possible acceleration.

The first underwater propulsion unit is advantageously pre-set to a higher power class than the second underwater propulsion unit, the plastic housing of the first underwater propulsion unit having a larger cross-section and/or a greater length than the plastic housing of the second underwater propulsion unit.

It is thus possible to ensure that the first underwater propulsion unit having the higher power class has a locally increased spacing between the plastic housing and metal housing, as a result of which the heat transport between the plastic housing and metal housing can be optimized. Ultimately, as a result, the operating safety of the underwater propulsion unit in question can be improved. As a result, this also makes it possible for the first underwater unit, having the higher power class, to appear to be larger compared with the second underwater propulsion unit, as a result of which a purely optically identifiable suggestion of the higher power class can be achieved.

The object is further achieved by a boat comprising an underwater propulsion unit.

### BRIEF DESCRIPTION OF THE FIGURES

Preferred embodiments of the invention are explained in greater detail by way of the following description of the figures, in which:

FIG. 1 is a simplified schematic cross-sectional view of an underwater propulsion unit according to a first embodiment, in a sectional plane extending in a longitudinal direction of the underwater propulsion unit;

FIG. 2 is a detailed cross-sectional view of an underwater propulsion unit according to a further embodiment, in a sectional plane extending in a longitudinal direction of the underwater propulsion unit;

FIG. 3 is a schematic cross-sectional view of the underwater propulsion unit according to FIG. 2, in a sectional plane oriented perpendicularly to the longitudinal axis of the underwater propulsion unit;

FIG. 4 is a schematic cross-sectional view of the underwater propulsion unit according to a further embodiment, in a sectional plane extending in a longitudinal direction of the underwater propulsion unit;

FIG. 5 is a perspective view of the underwater propulsion unit from FIG. 4; and

FIG. 6 is a schematic view of an underwater propulsion unit, in which the shaft tube is connected to the metal housing.

### DETAILED DESCRIPTION

Preferred embodiments are described in the following, with reference to the figures. In this case, identical, similar, or identically acting elements are provided with identical reference signs in the different figures, and repeated description of these elements is omitted in part, in order to prevent redundancies.

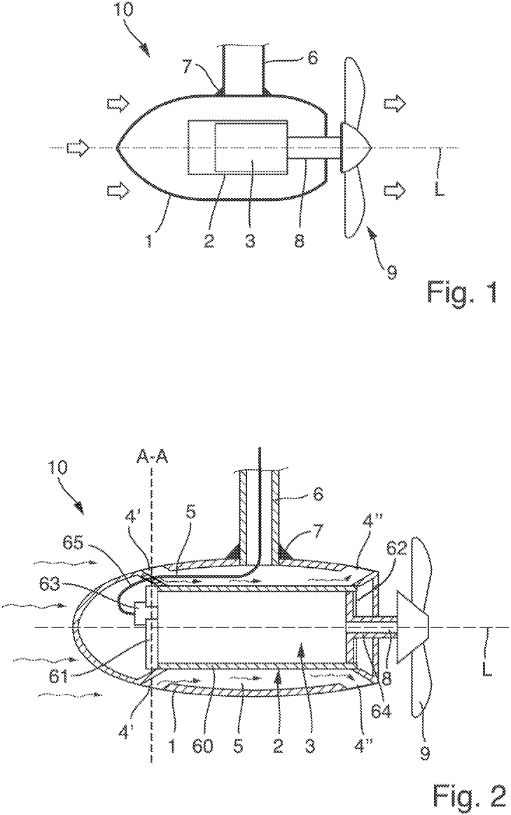

FIG. 1 is a simplified schematic cross-sectional view of an underwater propulsion unit 10 according to a first embodiment. The underwater propulsion unit 10 is shown in a sectional plane extending in a longitudinal direction L of the underwater propulsion unit. The underwater propulsion unit 10 comprises a plastic housing 1 designed for water to flow around, and a metal housing 2 which is arranged in the plastic housing 1 and in which an electrical drive 3 is received.

The metal housing 2 is designed so as to be watertight, and receives the electrical drive 3. The metal housing 2 is in turn arranged completely inside the plastic housing 1. Therefore, a “shell-in-shell” principle is used, specifically a “metal housing-in-plastic housing” principle. In this case, the outer shell, the plastic housing 1, fulfils the function of flow optimization, since in operation of the underwater propulsion unit 10 water flows around the plastic housing 1. In this case, the inner shell, the metal housing 2, fulfils the function of cooling the metal housing 2, and thus ultimately cooling the electrical drive 3. The metal housing 2 is untreated and was produced substantially without surface treatment.

The plastic housing 1 is connected to a shaft tube 6. The connection of the shaft tube 6 to the plastic housing 1 is achieved via a shaft tube molding 7. In this case, the shaft tube 6 does not have to be sealed. The underwater propulsion unit 10 can be connected to a boat (not shown) via the shaft tube 6. The propulsion of the underwater propulsion unit 10 is generated in that an electrical drive 3 in the metal housing 2 drives a drive shaft 8, on which a propeller 9 is mounted.

FIG. 2 is a detailed cross-sectional view of an underwater propulsion unit 10 according to a further embodiment, in a sectional plane extending in a longitudinal direction of the underwater propulsion unit 10. The plastic housing 1 comprises openings 4 which are connected via a flow channel 5. In this case, the plastic housing 1 is designed such that, in the state in which water flows around the plastic housing 1, it flows around the metal housing 2, at least in part.

The openings 4 comprise an inlet opening 4′ formed in the front region of the plastic housing 1, and an outlet opening 4″ formed in the rear region of the plastic housing 1. The flow channel 5 extends between the inlet opening 4′ and the outlet opening 4″, substantially along a longitudinal axis L of the underwater propulsion unit 10.

The flow channel 5 of the underwater propulsion unit 10 is formed in part by the metal housing 2. This means that, in the state in which water flows around the plastic housing 1, it reaches the metal housing 2, via the inlet opening 4′ into the flow channel 5, and wets said housing. The heat transport between the metal housing 2 and the water flowing therearound is promoted by the water-metal housing effective surface pair. The metal housing 2 is watertight.

The plastic housing 1 is connected to a shaft tube 6. The connection of the shaft tube 6 to the plastic housing 1 is achieved via a shaft tube molding 7. In this case, the shaft tube 6 does not need to be sealed. The underwater propulsion unit 10 can be connected to a boat (not shown) via the shaft tube 6. The propulsion of the underwater propulsion unit 10 is generated in that an electrical drive 3 the metal housing 2 drives a drive shaft 8, on which a propeller 9 is mounted.

The underwater propulsion unit 10 shown in FIG. 2 comprises two flow channels 5. Accordingly, the underwater propulsion unit 10 comprises two inlet openings 4′ and two outlet openings 4″. The inlet openings 4 and the outlet openings 4″ are in each case formed as separate openings 4 in the plastic housing 1.

According to the drawing in FIG. 2, the metal housing 2 further comprises a metal tube 60 which comprises a front tube seal 61 at a front end, and a rear tube seal 62 at the rear end thereof. The metal tube 60 is a simple, untreated metal tube. The front tube seal 61 and the rear tube seal 62 can in each case be understood as covers. The metal tube 2 is sealed, via said covers, against entry of water. The covers can be connected to the metal tube 60 by screw connections, in particular via flanges, and optionally additionally by means of suitable seals. Furthermore, the metal housing 2 comprises a cable seal 63 at the front end thereof and a shaft seal 64 at the rear end thereof. In the specific embodiment, the cable seal 63 is arranged on the front tube seal 63, and the shaft seal 64 is arranged on the rear tube seal 62.

By means of the cable seal 63, which is arranged in the front tube seal 61 of the metal housing 3, a cable 65 is conducted out of the metal housing 2, into the cable guide channel 50, in a manner sealed off against entry of water. Subsequently, the cable 65 is conducted out of the cable guide channel 50, on the shaft tube molding 7, into the shaft tube 6.

In this case, the electrical drive 3 can comprise i) a motor, ii) a motor comprising a transmission, iii) a motor comprising electronics, and iv) a motor comprising a transmission and electronics.

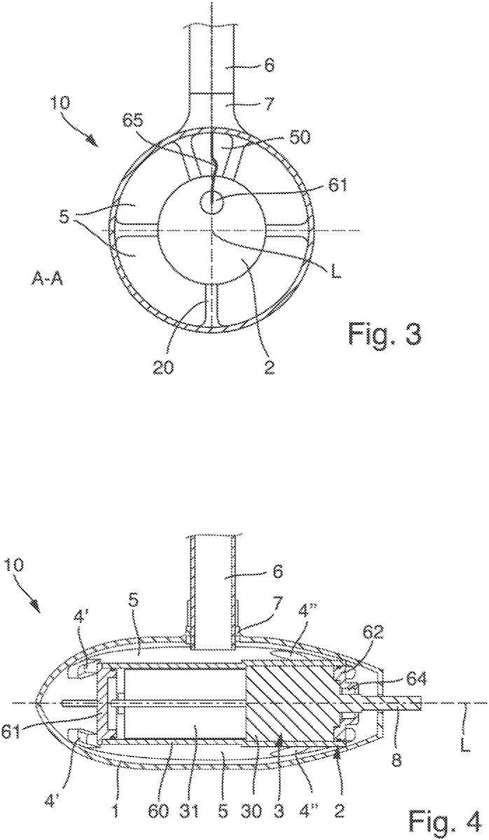

FIG. 3 is a schematic cross-sectional view of the underwater propulsion unit 10 according to the embodiment shown in FIG. 2, in a sectional plane A-A which is oriented perpendicularly to the longitudinal axis L and extends through the front tube seal 61.

Therefore, FIG. 3 shows the underwater propulsion unit 10 which comprises a plastic housing 1 designed for water to flow around, and a metal housing 2 which is arranged in the plastic housing 1 and comprises an electrical drive (not shown). In this case, the plastic housing 1 comprises a plurality of flow channels 5 which are separated from one another via longitudinal ribs 20. The longitudinal ribs furthermore fix the metal housing 2 and the plastic housing 1 to one another. In this case, the metal housing 2 is arranged substantially centrally in the plastic housing 1. Furthermore, the plastic housing 1 comprises a cable guide channel 50 between the metal housing 2 and the plastic housing 1.

Via the cable seal 63, which is arranged in the front tube seal 61 of the metal housing 3, the cable 65 is conducted out of the metal housing 2, into the cable guide channel 50, in a manner sealed off against entry of water. Subsequently, the cable 65 is conducted out of the cable guide channel 50, on the shaft tube molding 7, into the shaft tube 6.

FIG. 4 is a schematic cross-sectional view of the underwater propulsion unit 10 according to a further embodiment, in a sectional plane extending in the longitudinal direction 11. Accordingly, the drawing in FIG. 4 shows an underwater propulsion unit 10 which comprises a plastic housing 1 designed for water to flow around, and a watertight metal housing 2 which is arranged in the plastic housing 1 and comprises an electrical drive 3. The plastic housing 1 comprises a plurality of flow channels 5 which in each case extend between separate inlet openings 4 and separate outlet openings 5. In this case, the plastic housing 1 is designed such that, in the state in which water flows around the plastic housing 1, it flows around the metal housing 2, at least in part. In the specific example, the flow around the metal housing 2 takes place via the flow through the individual flow channels 5. In this case, the respective flow channels 5 are formed in part by the metal housing 2. In the state in which water flows around the plastic housing 1, the water flowing therearound wets the outside of the metal housing 2.

The plastic housing 1 is connected to a shaft tube 6, the connection being achieved via a shaft tube molding 7. The electrical drive 3 of the underwater propulsion unit comprises an electric motor 31, a transmission 30, and an electronics component, and drives a propeller (not shown) via a drive shaft 8.

The metal housing 2 of the underwater propulsion unit 10 comprises a cable seal 63 (not shown) at the front end thereof, for sealing a cable 65, and a shaft seal 64 at the rear end thereof. In this case, the cable seal 63 is arranged on a front tube seal 61 which is arranged at a front end of the metal tube 60. The shaft seal 64 is arranged on a rear tube seal 62 which is arranged at a rear end of the metal tube 60.

The inlet openings 4′ have a substantially rectangular cross section having rounded edges. The outlet openings 4″ have a substantially oval cross section. In this way, hydrodynamically induced flow losses can be reduced, as a result of which efficient cooling of the metal housing 2 is made possible.

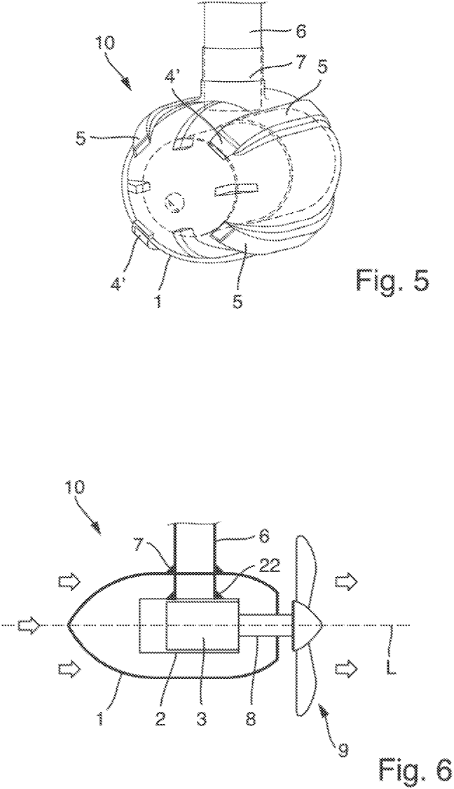

FIG. 5 is a perspective view of the underwater propulsion unit 10 from FIG. 4. As can be gathered from this drawing that the individual flow channels 5 of the underwater propulsion unit 10 comprise protrusions. In other words, the plastic housing 1 comprises protrusions. In this case, the respective inlet openings 4′ and outlet openings 4″ are formed at the start and end of each protrusion.

FIG. 6 shows an underwater propulsion unit 10 similar to the variant from FIG. 1, the difference here being that the shaft tube 6 is directly connected to the metal housing 2. In the embodiment shown, the connection is provided by a welding 22 of the shaft tube 6 to the metal housing 2.

The direct connection between the shaft tube 6 and the metal housing 2 can, however, also be achieved by screwing or riveting. In a further embodiment, the shaft tube 6 can be formed in one piece with the metal housing 2.

In the mentioned variants, the plastic housing 1 can likewise be connected to the shaft tube 6, as shown in FIG. 6. In this case, a shaft tube molding 7 is also provided, which serves for connecting the plastic housing 1 to the shaft tube 6.

However, in the case of a direct connection between the shaft tube 6 and the metal housing 2, the plastic housing 1 can also be arranged without contact with the shaft tube 6. The shaft tube 6 can be guided for example merely through one opening in the plastic housing 1.

If applicable, all the individual features set out in the embodiments can be combined and/or substituted with one another, without departing from the scope of the invention.

List of reference signs

| | |
|---|---|
| 1 | plastic housing |
| 2 | metal housing |
| 3 | electrical drive |
| 4 | openings |
| 4′ | inlet openings |
| 4″ | outlet openings |
| 5 | flow channel |
| 6 | shaft tube |
| 7 | shaft tube molding |
| 8 | drive shaft |
| 9 | propeller |
| 10 | underwater propulsion unit |
| 20 | longitudinal ribs |
| 22 | welding |
| 30 | transmission |
| 31 | electric motor |
| 50 | cable guide channel |
| 60 | metal tube |
| 61 | front tube seal |
| 62 | rear tube seal |
| 63 | cable seal |
| 64 | shaft seal |
| 65 | cable |

What is claimed:

1. An underwater propulsion unit comprising:
a plastic housing configured for water to flow around; and
a metal housing configured to receive an electrical drive so as to be sealed off from surroundings in a watertight manner,
wherein the metal housing is arranged inside the plastic housing that includes a plurality of openings that are connected via a flow channel, and
wherein the plastic housing is configured such that, when the water flows around the plastic housing, the water flows at least partially around the metal housing.

2. The underwater propulsion unit according to claim 1, wherein the plastic housing comprises an inlet opening in a front region, and an outlet opening in a rear region, and the flow channel extends along a longitudinal axis of the underwater propulsion unit.

3. The underwater propulsion unit according to claim 1, wherein the flow channel is at least partially formed by the metal housing.

4. The underwater propulsion unit according to claim 1, wherein the plastic housing is connected to a shaft tube via a shaft tube molding.

5. The underwater propulsion unit according to claim 1, wherein the electrical drive comprises at least one of an electric motor, an optional transmission, and an electronic component.

6. The underwater propulsion unit according to claim 5, wherein the electrical drive is configured to drive a propeller via a drive shaft.

7. The underwater propulsion unit according to claim 1, wherein the metal housing comprises a metal tube that includes at least one of a front tube seal at a front end and a rear tube seal at a rear end thereof.

8. The underwater propulsion unit according to claim 7, wherein the metal housing comprises a cable seal at the front end thereof, for sealing a cable, and a shaft seal at the rear end thereof.

9. The underwater propulsion unit according to claim 1, wherein the plastic housing comprises a plurality of flow channels.

10. The underwater propulsion unit according to claim 9, wherein the flow channels are separated from one another by longitudinal ribs that fix the metal housing to and the plastic housing.

11. The underwater propulsion unit according to claim 9, wherein the flow channels each open out into at least one of separate inlet openings and outlet openings in the plastic housing.

12. The underwater propulsion unit according to claim 8, wherein the flow channels open out into at least one of a common inlet distributor and outlet distributor having a common inlet opening or outlet opening, respectively.

13. The underwater propulsion unit according to claim 1, wherein the metal housing is arranged substantially centrally in the plastic housing, and the plastic housing includes a cable guide channel between the metal housing and the plastic housing.

14. The underwater propulsion unit according to claim 2, wherein at least one of the openings and the flow channel comprise fixed or variable flow limitation means to adjust a flow through the flow channel.

15. The underwater propulsion unit according to claim 2, wherein at least one of the openings and the flow channel comprises turbulators that are connected to the metal housing.

16. The underwater propulsion unit according to claim 1, wherein the shaft tube is directly connected to the metal housing.

17. The underwater propulsion unit according to claim 6, wherein the shaft tube is directly connected to the metal housing by at least one of being welded, begin screwed or being riveted to the metal housing, and the shaft tube is formed in one piece with the metal housing.

18. A system comprising:
at least two underwater propulsion units according to claim 1,
wherein the at least two underwater propulsion units comprise at least one of an electrical drive of identical construction and a metal housing of identical construction,
wherein each electrical drive is pre-set to a different power class, and
wherein at least one dimension of the plastic housing is selected depending on the pre-set power class.

19. The system according to claim 18, wherein the first underwater propulsion unit is pre-set to a higher power class than the second underwater propulsion unit, and the plastic housing of the first underwater propulsion unit has at least one of a larger cross-section and a greater length than the plastic housing of the second underwater propulsion unit.

20. A boat comprising an underwater propulsion unit according to claim 1.
